(19) United States
(12) Patent Application Publication
(10) Pub. No.: US 2008/0256480 A1
(43) Pub. Date: Oct. 16, 2008

(54) DATA GATHERING AND PROCESSING SYSTEM

(75) Inventors: Michio Kimura, Saitama (JP); Toshiroh Shimizu, Shizuoka (JP); Terutaka Furuta, Aichi (JP); Takeshi Numano, Aichi (JP)

Correspondence Address: STEIN, MCEWEN & BUI, LLP, 1400 EYE STREET, NW, SUITE 300, WASHINGTON, DC, 20005, US

(73) Assignees: SBS Information Systems Co., Ltd., Shizuoka (JP); NTT Data Tokai Corporation, Aichi (JP); Michio Kimura, Saitama (JP)

(21) Appl. No.: 12/062,916

(22) Filed: Apr. 4, 2008

(30) Foreign Application Priority Data
Apr. 6, 2007 (JP) 2007-100961

(51) Int. Cl. G06F 3/048

(52) U.S. Cl. 715/780

(57) ABSTRACT

A data gathering and processing system capable of efficiently gathering data and easily putting gathered data to secondary use in various applications. The data gathering and processing system includes an XML file generation unit that generates a structured document with data describing the layout of a data entry screen that includes input data, an item extraction unit that extracts, as a search item, at least a tag name from the structured document with data, an XML database that stores, in association with at least a portion of the structured document with data, the search item extracted by the item extraction unit from the structured document with data, a search criteria setting unit that receives a search item and a search criteria from a searcher, and a search execution unit that searches the XML database based on the search criteria, and presents input data obtained as a search result or a data entry screen that includes the input data.

### CROSS-REFERENCE TO RELATED APPLICATION

This application claims the benefit of Japanese Patent Application No. 2007-100961, filed Apr. 6, 2007, in the Japanese Patent Office, the disclosures of which are incorporated herein by reference.

### BACKGROUND OF THE INVENTION

1. Field of the Invention

The present invention relates to a data gathering and processing system, usable in clinical trials or the like, for example, that is capable of efficiently gathering data and easily putting gathered data to secondary use in various applications.

2. Description of the Related Art

Heretofore, data gathering and processing systems for gathering data completed on a prescribed sheet or data entered into a prescribed form on a screen, and managing the gathered data by computer have been widely used in various fields.

In particular, being able to create data entry screens using a so-called structured document such as HTML (HyperText Markup Language) or XML (Extensible Markup Language) has become relatively easy in recent years. The growth of network communication technologies such as the Internet has meant that large amounts of data can be gathered efficiently by gathering data entered into the data entry screen of a terminal in servers or the like. Processing data entered into a data entry screen created with a structured document such as the above based on the tag names of the structured document also enables input data to be registered in a database efficiently (e.g., see JP 2000-99606 A).

However, while JP 2000-99606 A discloses a method of registering input data in a database, nothing is disclosed in relation to easily putting the registered data to secondary use.

### SUMMARY OF THE INVENTION

In view of the above, an object of the present invention is to provide a data gathering and processing system capable of efficiently gathering data and easily putting gathered data to secondary use in various applications.

To achieve the above object, a data gathering and processing system according to the present invention includes a template storage unit storing a structured document describing a template of a data entry screen layout, a display unit that displays a data entry screen by analyzing a structured document corresponding to a template selected by a data inputter, an input data storage unit that, when there is data entry to the data entry screen, at least temporarily stores input data in association with a tag name corresponding to the input data, a structured document generation unit that, when data entry to the data entry screen is complete, generates a structured document with data describing a layout of a data entry screen that includes input data, with reference to a structured document corresponding to a template of the data entry screen, and to the input data and the tag name stored in the input data storage unit, an item extraction unit that extracts, as a search item, at least a tag name from the structured document with data, a database that stores, in association with at least a portion of the structured document with data, the search item extracted by the item extraction unit from the structured document with data, a search criteria setting unit that displays the search item and receives a search criteria related to the search item from a searcher, and a search execution unit that searches the database based on the search criteria received from the searcher, and presents input data obtained as a search result or a data entry screen that includes the input data.

In the data gathering and processing system according to the present invention, HTML or XML, for example, can be suitably used as the aforementioned structured document. Also, the data gathering and processing system according to the present invention is able to handle data related to a clinical trial as the input data.

To achieve the above object, a computer program according to the present invention causes a computer to execute the processes of displaying a data entry screen by reading out, from a template storage unit storing a structured document describing a template of a data entry screen layout, a structured document corresponding to a template selected by a data inputter and analyzing the read structured document, at least temporarily storing in an input data storage unit when there is data entry to the data entry screen, input data in association with a tag name corresponding to the input data, generating, when data entry to the data entry screen is complete, a structured document with data describing a layout of a data entry screen that includes input data, with reference to a structured document corresponding to a template of the data entry screen, and to the input data and the tag name stored in the input data storage unit, extracting, as a search item, at least a tag name from the structured document with data, and storing, in a database, the extracted search item in association with at least a portion of the structured document with data, displaying the search item and receiving a search criteria related to the search item from a searcher, and searching the database based on the search criteria received from the searcher, and presenting input data obtained as a search result or a data entry screen that includes the input data.

The present invention enables a data gathering and processing system capable of gathering data efficiently and easily putting gathered data to secondary use in various applications to be provided.

### BRIEF DESCRIPTION OF THE DRAWINGS

FIG. 1 is a block diagram showing a schematic configuration of a data gathering and processing system according to a first embodiment of the present invention.

FIG. 2 is a block diagram showing a schematic of functional configurations of a user terminal and a data gathering server provided in the data gathering and processing system.

FIG. 3 is an illustrative diagram showing an exemplary data entry screen used in the data gathering and processing system.

FIG. 4A is exemplary XML describing a template of the data entry screen.

FIG. 4B is exemplary XML describing a template of the data entry screen (cont. from FIG. 4A).

FIG. 4C is exemplary XML describing a template of the data entry screen (cont. from FIG. 4B).

FIG. 4D is exemplary XML describing a template of the data entry screen (cont. from FIG. 4C).

FIG. 4E is exemplary XML describing a template of the data entry screen (cont. from FIG. 4D).

FIG. 4F is exemplary XML describing a template of the data entry screen (cont. from FIG. 4E).

FIG. 4G is exemplary XML describing a template of the data entry screen (cont. from FIG. 4F).

FIG. 4H is exemplary XML describing a template of the data entry screen (cont. from FIG. 4G).

FIG. 5 is a flowchart showing a data gathering and processing procedure in the data gathering and processing system.

FIG. 6 is an illustrative diagram showing an example of data having been entered into the data entry screen shown in FIG. 3.

FIG. 7 is an illustrative diagram showing an example of input data and tag names acquired from the data entry screen with data entered therein shown in FIG. 6.

FIG. 8A is exemplary XML generated from the data entry screen with data entered therein shown in FIG. 7.

FIG. 8B is exemplary XML generated from the data entry screen with data entered therein shown in FIG. 7 (cont. from FIG. 8A).

FIG. 8C is exemplary XML generated from the data entry screen with data entered therein shown in FIG. 7 (cont. from FIG. 8B).

FIG. 8D is exemplary XML generated from the data entry screen with data entered therein shown in FIG. 7 (cont. from FIG. 8C).

FIG. 8E is exemplary XML generated from the data entry screen with data entered therein shown in FIG. 7 (cont. from FIG. 8D).

FIG. 8F is exemplary XML generated from the data entry screen with data entered therein shown in FIG. 7 (cont. from FIG. 8E).

FIG. 8G is exemplary XML generated from the data entry screen with data entered therein shown in FIG. 7 (cont. from FIG. 8F).

FIG. 8H is exemplary XML generated from the data entry screen with data entered therein shown in FIG. 7 (cont. from FIG. 8G).

FIG. 9 is a flowchart showing a data search procedure in the data gathering and processing system.

FIG. 10 is an illustrative diagram showing an exemplary search item selection screen in the case where the data of the XML template of FIGS. 4A to 4H is searched.

FIG. 11 is an illustrative diagram showing the search item selection screen when the searcher has further selected “Observation Date” as a search item on the search item selection screen shown in FIG. 10.

FIG. 12 is an illustrative diagram showing an exemplary search results screen.

FIG. 13 is an illustrative diagram showing a mode in which a search result is displayed as an image of a data entry screen.

FIG. 14 shows an exemplary CRF.

FIG. 15 is a block diagram showing a schematic of functional configurations of a terminal of a medical institution and a clinical trial data gathering server in the data gathering and processing system according to a second embodiment of the present invention.

FIG. 16 is an illustrative diagram showing an exemplary data entry screen used in the data gathering and processing system.

FIG. 17 is an illustrative diagram showing an example of data having been entered into the data entry screen of FIG. 16.

### DETAILED DESCRIPTION OF THE INVENTION

Hereinafter, embodiments of a data gathering and processing system according to the present invention will be described by way of examples, and configurations and operations thereof will be described with reference to the drawings.

### First Embodiment

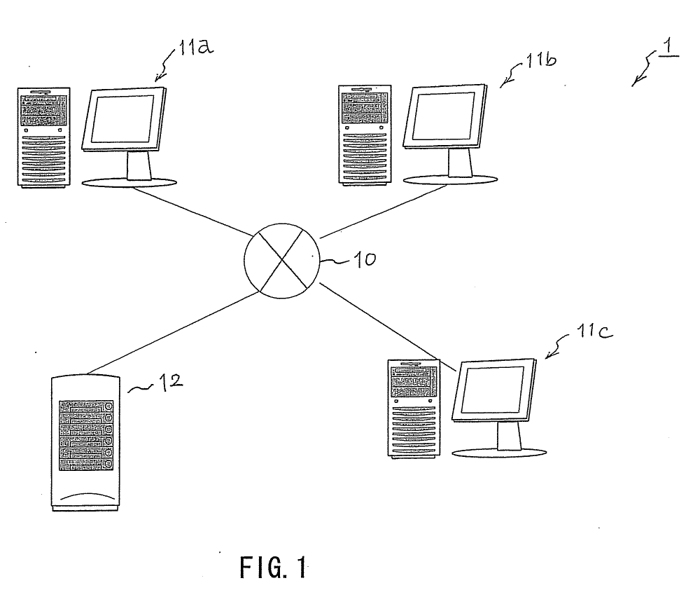

FIG. 1 is a block diagram showing a schematic configuration of a data gathering and processing system according to a first embodiment of the present invention. As shown in FIG. 1, the data gathering and processing system 1 according to the present embodiment is constituted with a plurality of user terminals 11a, 11b, 11c, and so on communicably connected to a data gathering server 12 via a communication network 10. Note that in the following description, the user terminals 11a, 11b, 11c, and so on will be referred to as user terminal 11 where there is no need to distinguish between them. Also, while only three user terminals are illustrated in FIG. 1, the number of user terminals is arbitrary. The communication network 10 may be a wide area network such as the Internet, or a local area network (LAN). Further, the embodiments of the present invention are not limited to the network configuration shown in FIG. 1. A standalone configuration realized by a single personal computer or server is also possible.

The user terminal 11 is realized, for example, by a personal computer with a browser installed, and displays data entry screens written in a structured document (XML in the present embodiment) on a display. The user terminal 11 is, however, not limited to a personal computer. The user terminal 11 may be a mobile terminal such as a PDA (Personal Digital Assistant) or a mobile telephone, on condition that a browser can be loaded.

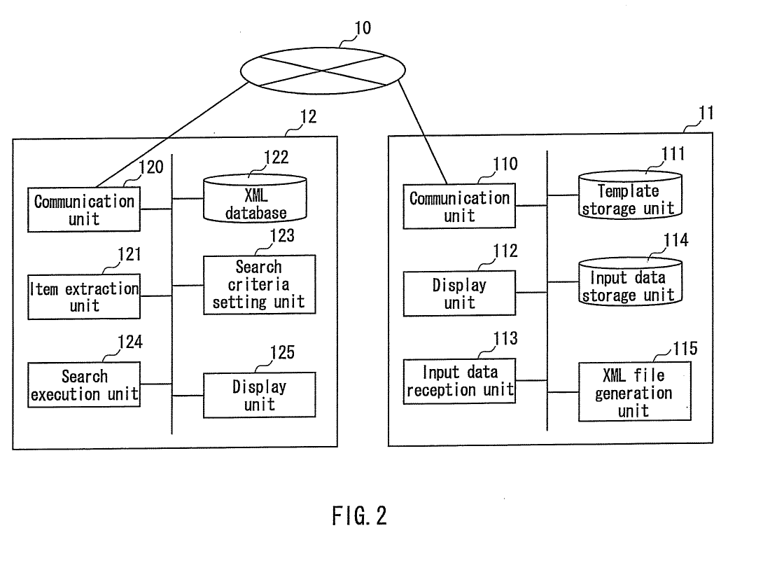

Here, the functional schematic configuration of the user terminal 11 is shown in FIG. 2. As shown in FIG. 2, the user terminal 11 is provided with a communication unit 110, a template storage unit 111, a display unit 112, an input data reception unit 113, an input data storage unit 114 and an XML file generation unit (structured document generation unit) 115. Note that while provided internally to the user terminal 11 (e.g., on an internal hard disk) in the FIG. 2 example, the template storage unit 111 and the input data storage unit 114 may be constructed externally to the user terminal 11 (e.g., on a disk apparatus or file server accessible from the user terminal 11). Also, while FIG. 2 shows an example in which the template storage unit 111 is provided in the user terminal 11, a template storage unit may be disposed in the data gathering server 12, and when a data inputter selects a template, XML corresponding to the selected template may be transmitted from the data gathering server 12 to the user terminal 11. The communication unit 110, the display unit 112, the input data reception unit 113 and the XML file generation unit 115 in the user terminal 11 are respectively functional means realized as a result of a processor of the user terminal 11 running a prescribed computer program, and need not necessarily be implemented separately as independent hardware.

The communication unit 110 performs communication with the data gathering server 12 and with other user terminals as necessary, via the communication network 10.

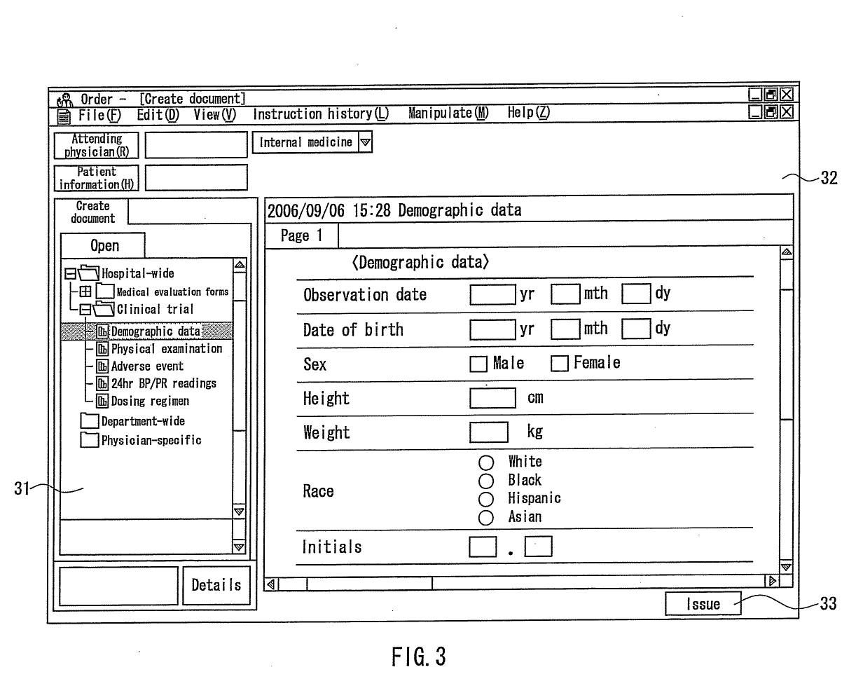

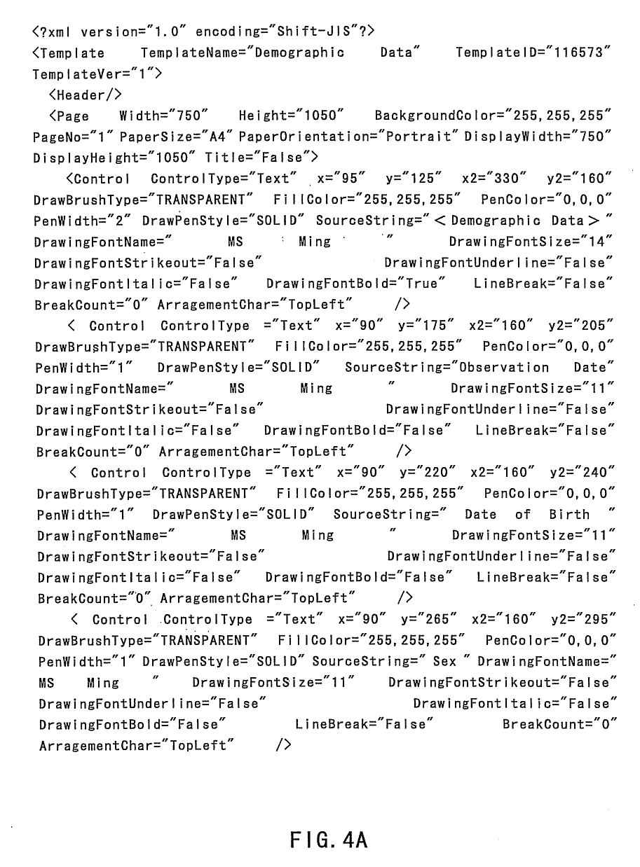

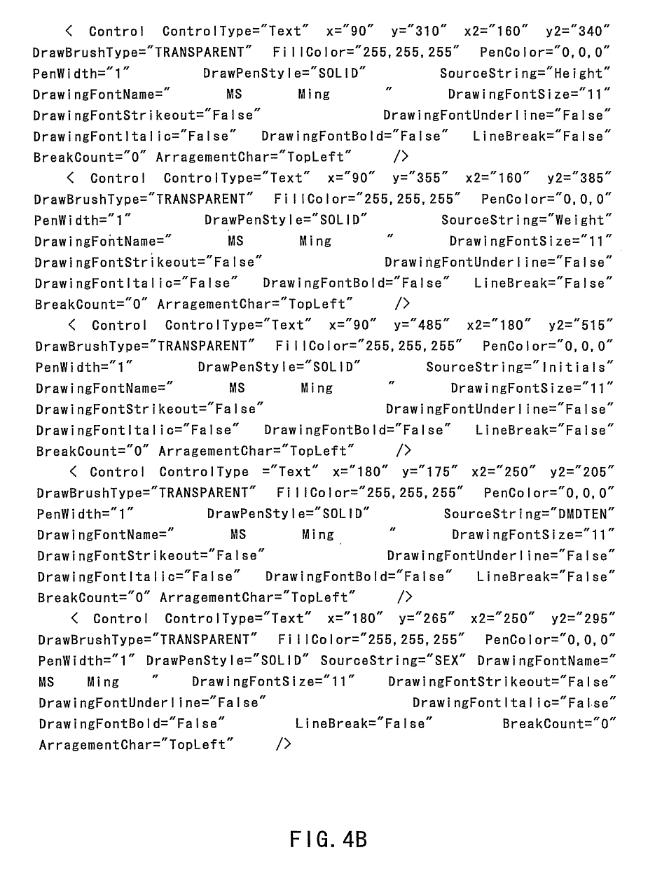

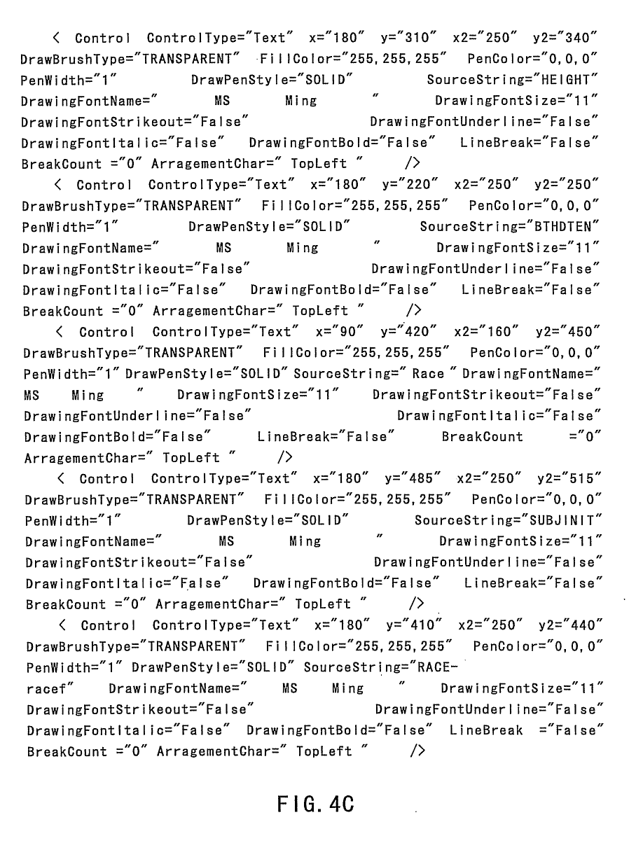

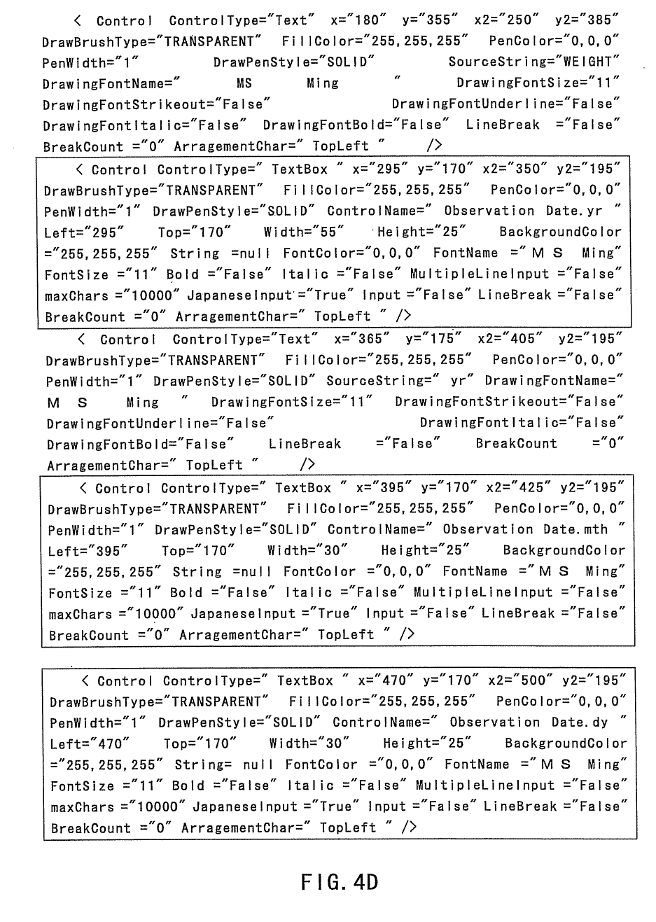

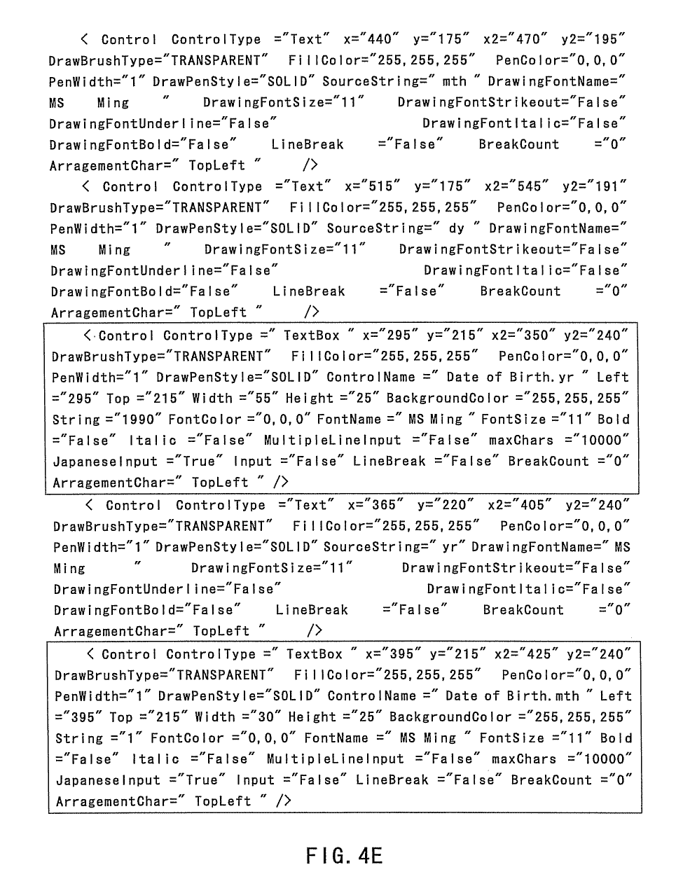

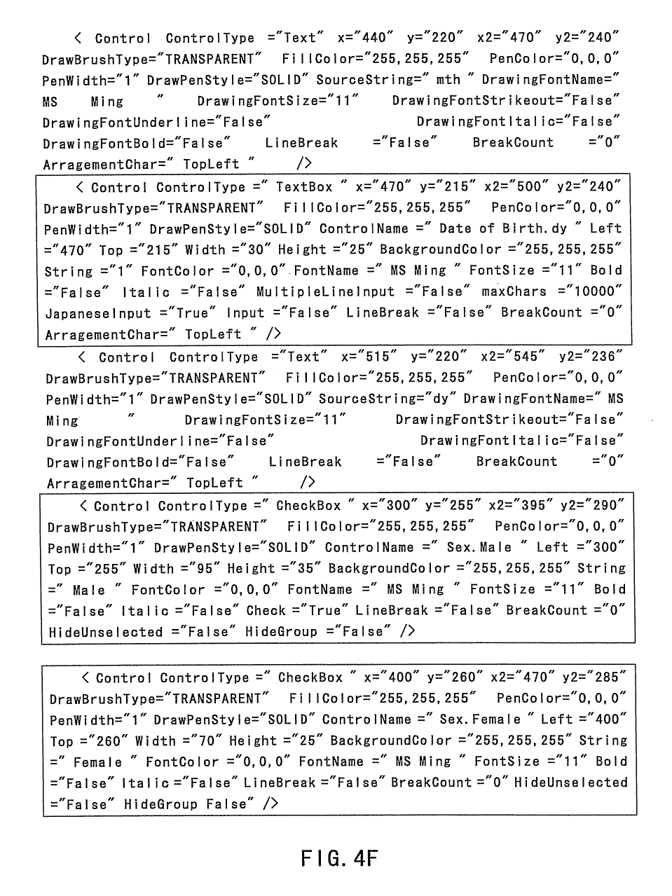

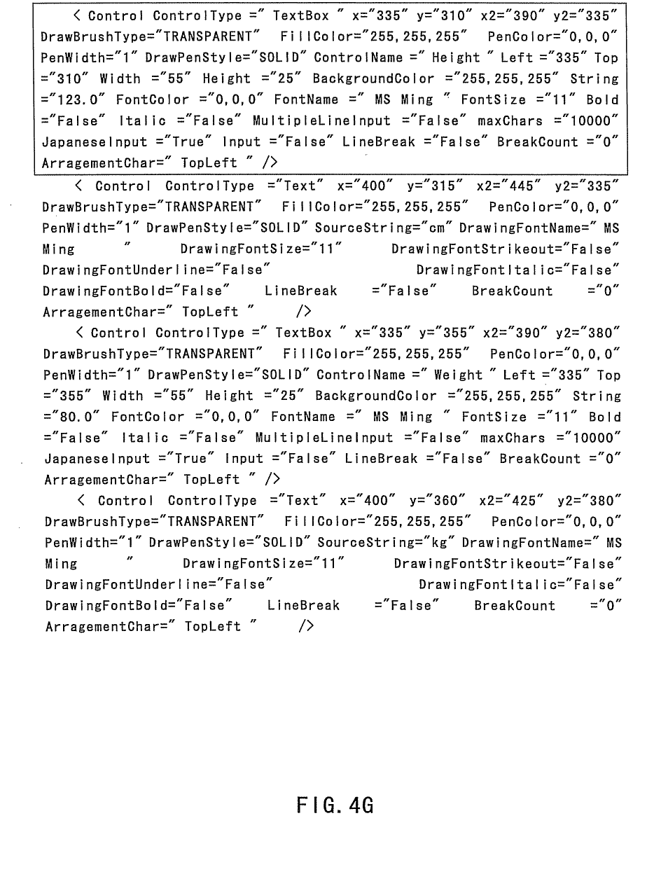

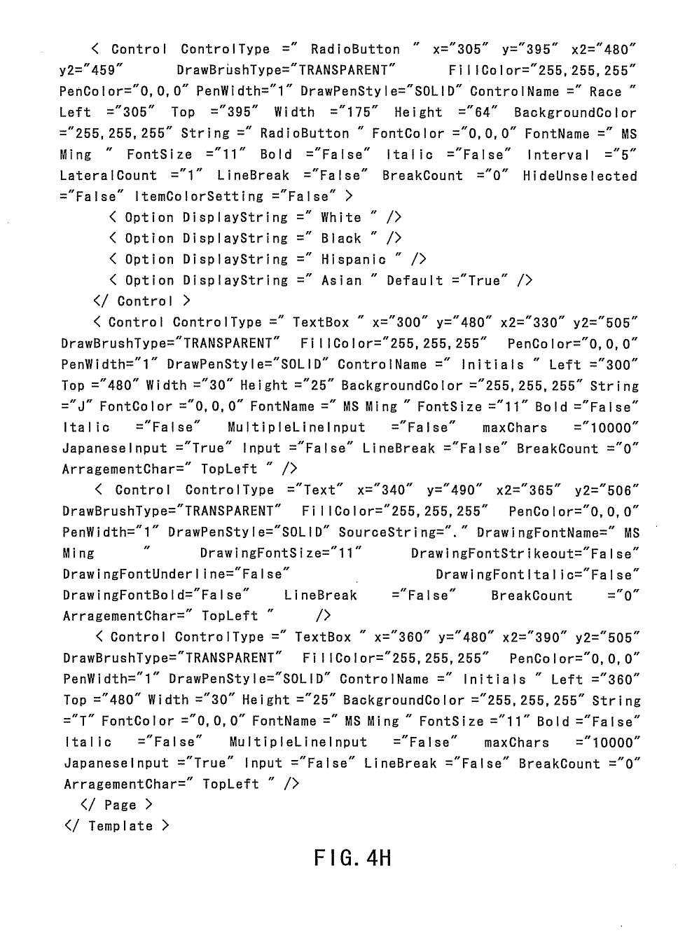

The template storage unit 111 stores document definitions written in XML as the templates of data entry screens for use in the user terminal 11. With the data entry screen shown in FIG. 3, for example, various templates for data entry can be selected in a document selection field 31 on the left side of the screen. The FIG. 3 example shows “Demographic Data” as having been selected as one of the data entry screens related to “Clinical Trial”, and the corresponding data entry screen being displayed on a main screen 32. That is, the display unit 112 displays a data entry screen on the user terminal 11 by extracting XML defining the template selected in the document selection field 31 from the template storage unit 111, and analyzing the extracted XML of the template. The XML defining the “Demographic Data” template shown in FIG. 3 is as shown in FIGS. 4A to 4H. Note that in FIGS. 4A to 4H, places that include the XML description of tags corresponding to the entry fields in the data entry screen have been boxed.

The input data reception unit 113 detects data entered into the data entry screen displayed on the user terminal 11, and at least temporarily stores the detected data in the input data storage unit 114 together with the tag name in relation to which the data was entered. Once data entry to the data entry screen is complete, the XML file generation unit 115 generates an XML file with data describing the layout of the data entry screen that includes input data, with reference to the template storage unit 111 and the input data storage unit 114. The generated XML file with data is sent from the user terminal 11 to the data gathering server 12 via the communication network 10.

The data gathering server 12 is provided with a communication unit 120, an item extraction unit 121, an XML database 122, a search criteria setting unit 123, a search execution unit 124 and a display unit 125, as shown in FIG. 2. Note that while constructed internally to the data gathering server 12 (e.g., on an internal hard disk) in the FIG. 2 example, the XML database 122 may be constructed externally to the data gathering server 12 (e.g., on a disk apparatus or file server accessible from the data gathering server 12). The communication unit 120, the item extraction unit 121, the search criteria setting unit 123, the search execution unit 124 and the display unit 125 are respectively functional means realized as a result of a processor of the data gathering server 12 running a prescribed computer program, and need not necessarily be implemented separately as independent hardware.

The communication unit 120 performs communication with the respective user terminals 11a, 11b, 11c, and so on, via the communication network 10.

The item extraction unit 121 extracts tag names corresponding to the input fields of the data entry screen from the XML file with data sent from the user terminal 11. The XML database 122 stores an XML file with data sent from a user terminal in association with the tag names extracted from the XML file by the item extraction unit 121.

The search criteria setting unit 123 acquires and displays search items from the XML database 122, and allows a searcher to select a search item as necessary, as well as receiving search criteria related to the search item. The search execution unit 124 searches the XML database 122 based on the search criteria received from the searcher. The search results are presented to the searcher by the display unit 125 in an appropriate format or in the format of the data entry screen that includes the input data. Note that while the entry of search criteria and the display of search results may be performed using an input apparatus and a display apparatus provided in the data gathering server 12, these operations may also be performed using an input apparatus and a display apparatus provided in any of the user terminals 11. Alternatively, the search may be performed using a terminal, other than the user terminals 11 or the data gathering server 12, capable of accessing the data gathering server 12 via the communication network 10.

Next, the operations of the data gathering and processing system 1 according to the above configuration will be described.

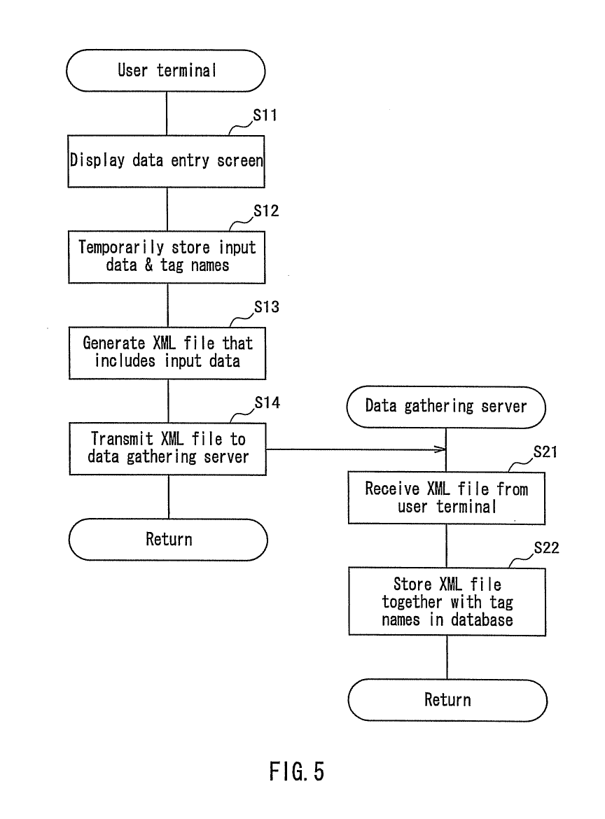

Firstly, the data gathering and processing procedure in the data gathering and processing system 1 according to the present embodiment will be described, mainly with reference to FIG. 5. FIG. 5 is a flowchart showing the data gathering and processing procedure in the data gathering and processing system 1.

Once the data inputter has selected the template of a data entry screen in the user terminal 11, the display unit 112 of the user terminal 11 displays the data entry screen by reading out, from the template storage unit 111, XML corresponding the template selected by the data inputter and analyzing the read XML (step S11).

Once data has been entered by the data inputter into the data entry screen displayed on the user terminal 11, the input data reception unit 113 acquires this input data, and stores the acquired input data in the input data storage unit 114 in association with the tag names corresponding to the input data (step S12).

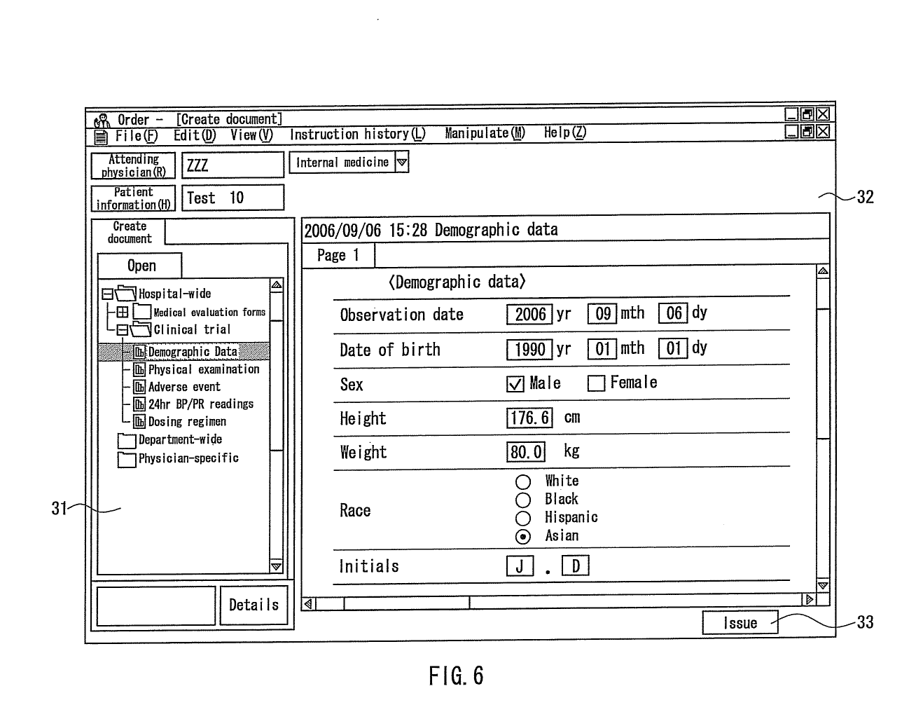

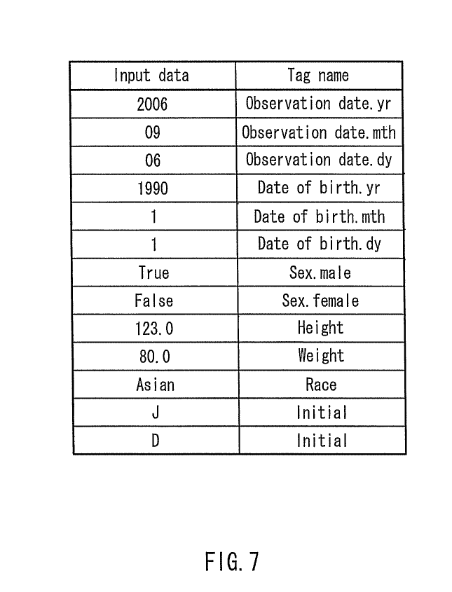

Here, assume that data has been entered as shown in FIG. 6, for example, into the “Demographic Data” data entry screen shown in FIG. 3. In this case, with the data “2006” year, “09” month and “06” day entered as the observation date, “2006” is string data entered into the “Observation Date.yr” tag (control) defined in the XML shown in FIG. 4D, “09” is string data entered into the “Observation Date.mth” tag, and “06” is string data entered into the “Observation Date.dy” tag. The input data reception unit 113 acquires the string data “2006”, “09” and “06” as input data, and stores the acquired data in the input data storage unit 114 in association respectively with “Observation Date.yr”, “Observation Date.mth” and “Observation Date.dy”. Other data entered into the data entry screen in FIG. 6, that is, date of birth, sex, height, weight, race and initials, are similarly processed by the input data reception unit 113, and the input data is at least temporarily stored in the input data storage unit 114 in association with the tag names. FIG. 7 shows input data and tag names acquired from the data entry screen with data entered therein shown in FIG. 6, as an example of input data and tag names at least temporarily stored in the input data storage unit 114.

Once data entry to the data entry screen is thereby complete, and the data inputter has clicked an Issue button 33 on the data entry screen, the XML file generation unit 115 generates an XML file describing the layout of the data entry screen that includes input data, with reference to the XML of the template of the data entry screen and to the input data and tag names stored in the input data storage unit 114 (step S13).

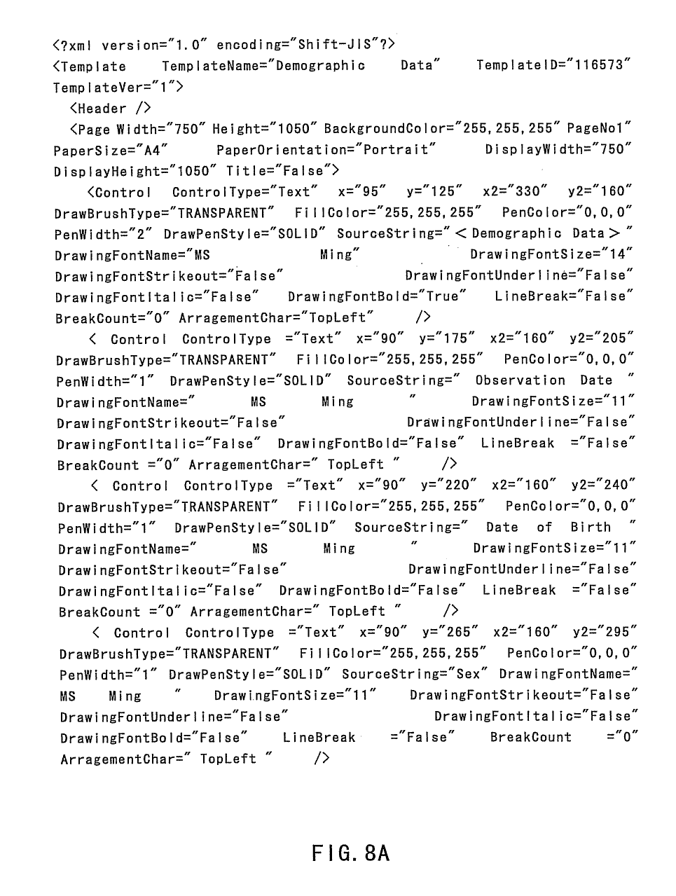

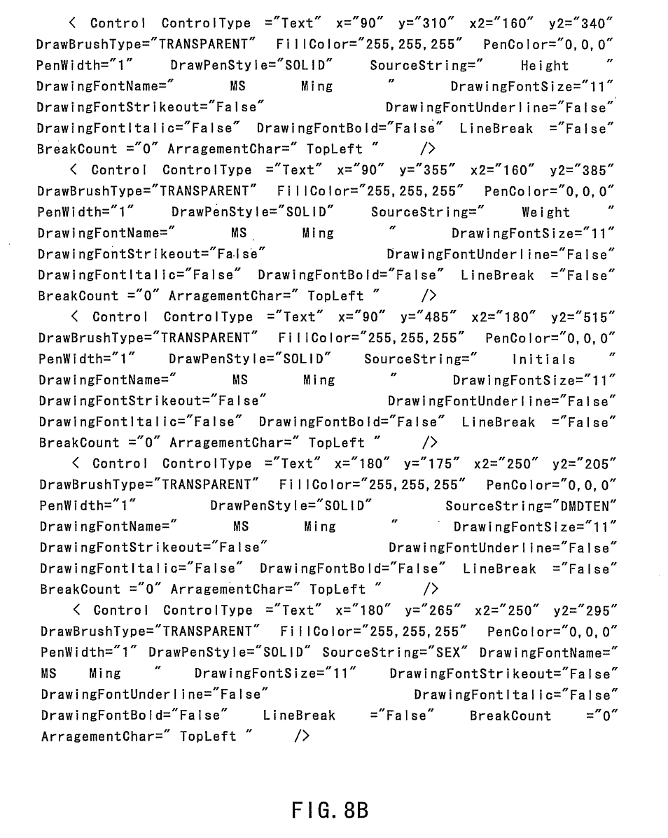

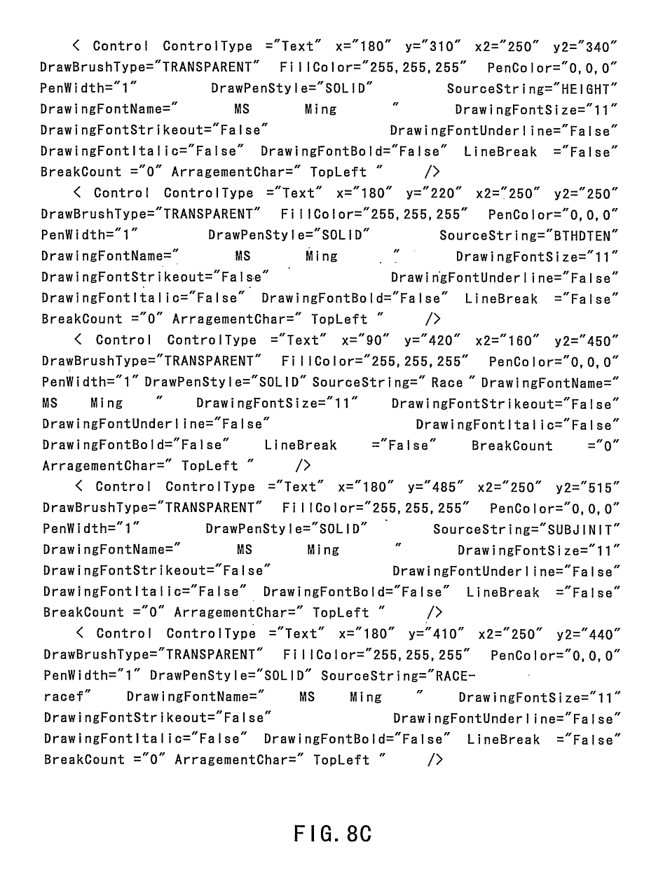

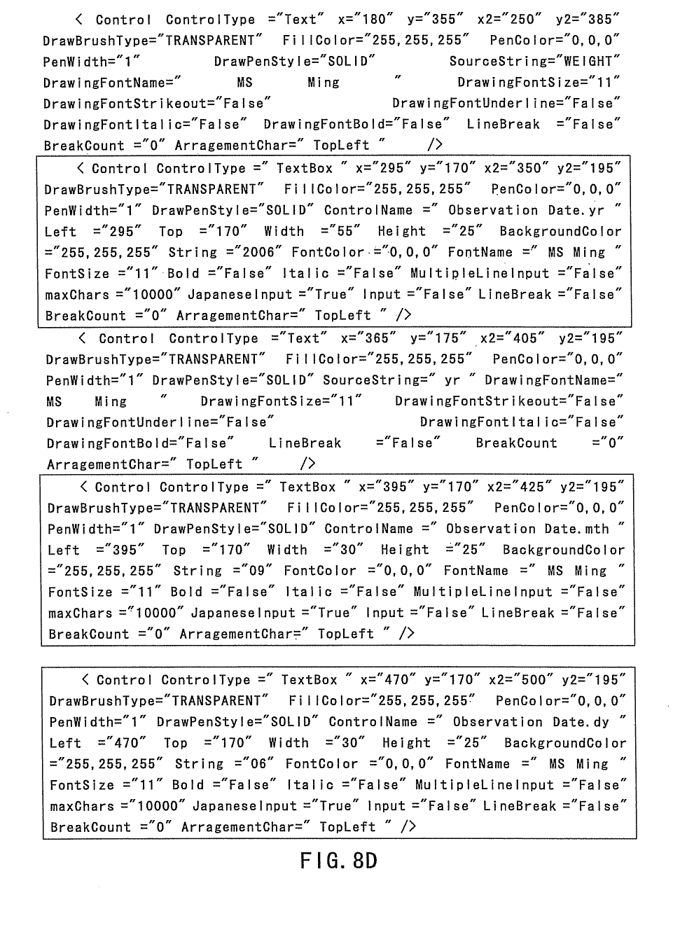

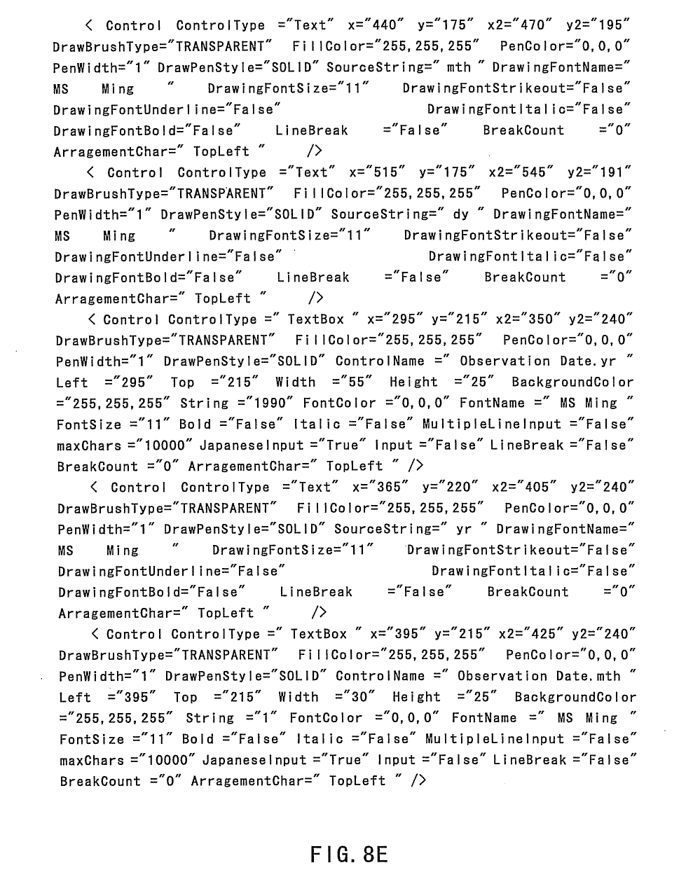

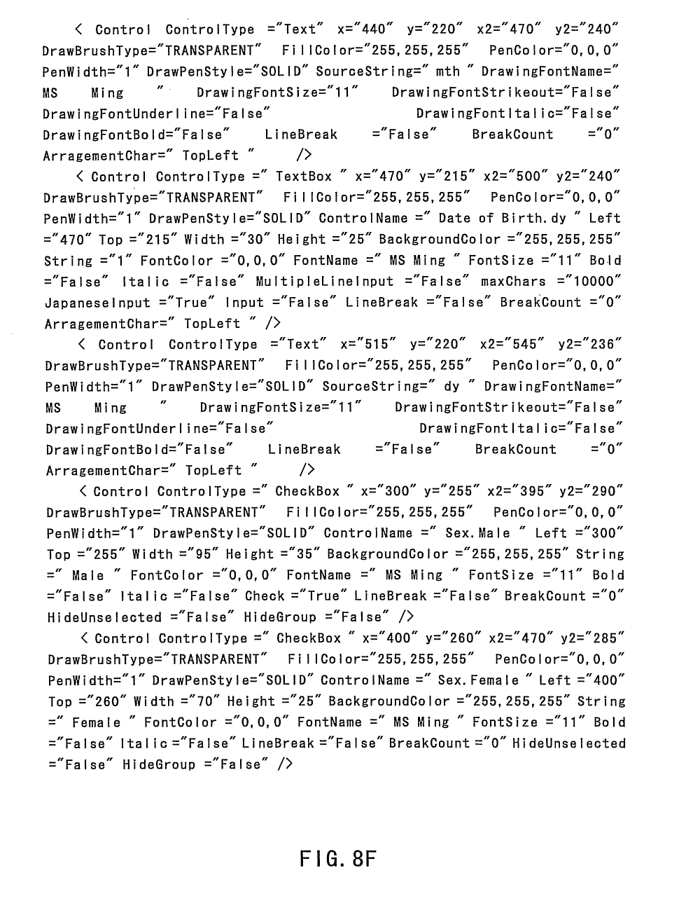

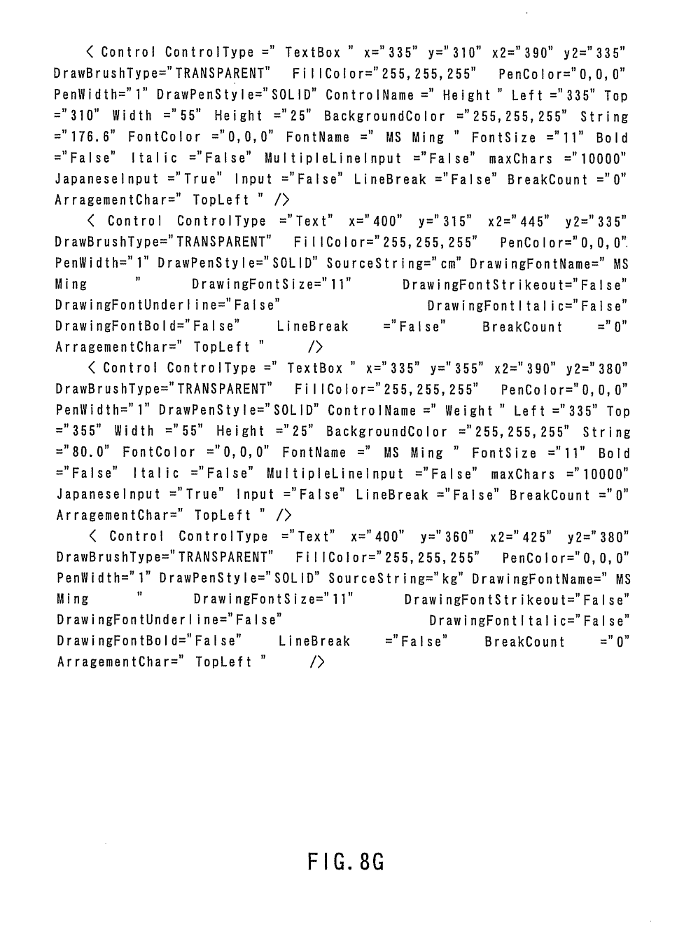

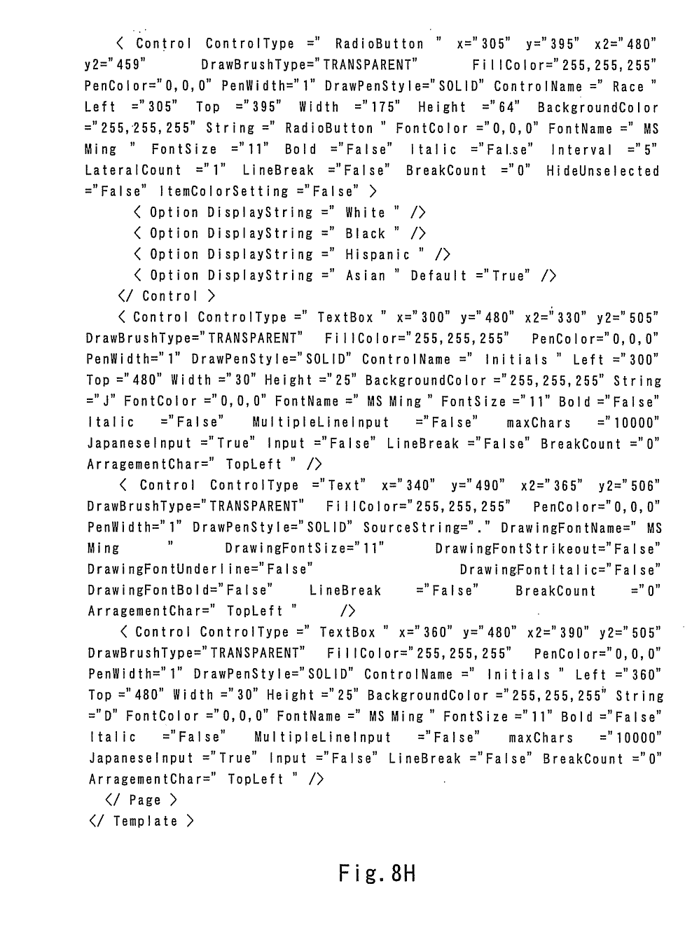

For example, XML such as shown in FIGS. 8A to 8H is generated by the XML file generation unit 115 from the data entry screen with data entered therein shown in FIG. 6. As evident from a comparison of FIGS. 4A to 4H and FIGS. 8A to 8H, the XML generated by the XML file generation unit 115 includes description related to the data that has been entered. That is, the XML file generation unit 115 refers to the tag names stored in the input data storage unit 114, and embeds the input data associated with these tag names in the tags (controls) of these tag names in the XML of the template.

The XML file generated in step S13 as described above is sent by the communication unit 110 of the user terminal 11 to the data gathering server 12 via the communication network 10 (step S14).

In the data gathering server 12, the communication unit 120 receives the XML file sent from the user terminal 11 (step S21). The received XML file is stored in the XML database 122. At this time, the item extraction unit 121 extracts the tag names corresponding to input data items from the XML file, and stores the extracted tag names in the XML database 122 in association with the XML file (step S22). The tag names extracted by the item extraction unit 12 are used as options for allowing a searcher to select a search item in the search process described below. Note that when storing a received XML file in the XML database 122, parts of the description not related to the input data in the XML file may be removed, for example, and only those parts including description related to significant input data may be stored in the XML database 122 in order to conserve storage capacity.

The above procedure enables data entered at the user terminal 11 to be gathered in the XML database 122 of the data gathering server 12 as an XML file. Note that while the process of extracting tag names corresponding to input data items from an XML file is performed in the item extraction unit 121 provided in the data gathering server 12 in the above description, the tag name extraction process may be performed in the user terminal 11, and the extracted tag names sent to the data gathering server 12 together with the XML file and stored in the XML database 122.

Note that in the case where options or the like for a tag name are described in the XML, the item extraction unit 121, rather than only extracting the tag name as a search item from the XML file, preferably extracts these options or the like as search criteria for the search item. For example, the options “White”, “Black”, “Hispanic” and “Asian” are described in the XML for the tag name “Race” in the above example, so these options preferably are extracted as search criteria for the search item “Race”.

Also, in the case where there is a dominant concept common to a plurality of tags, the item extraction unit 121 may extract the item name representing the dominant concept of those tag names as a search item. For example, the item extraction unit 121 may extract “Observation Date”, as the dominant concept of the three tag names “Observation Date.yr”, “Observation Date.mth” and “Observation Date.dy”, in the above example.

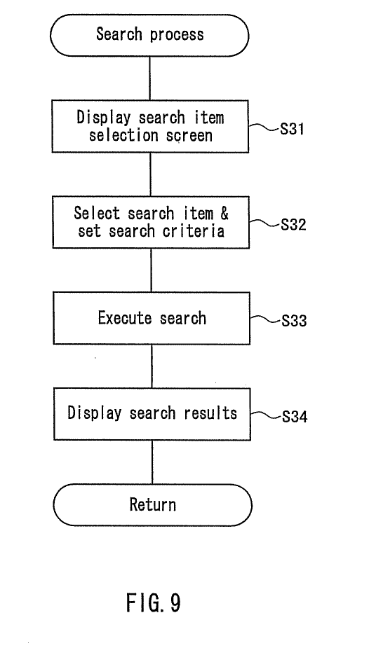

Next, a search process using data gathered in the XML database 122 as aforementioned will be described with reference to FIG. 9 and other drawings. FIG. 9 is a flowchart showing a data search procedure in the data gathering and processing system 1 according to the present embodiment.

Note that, as described above, the data search process may be performed in the data gathering server 12 or in one of the user terminals 11, or alternatively using a terminal, other than the user terminals 11 or the data gathering server 12, capable of accessing the data gathering server 12 via the communication network 10. In the example described here, the search process is performed in one of the user terminals 11.

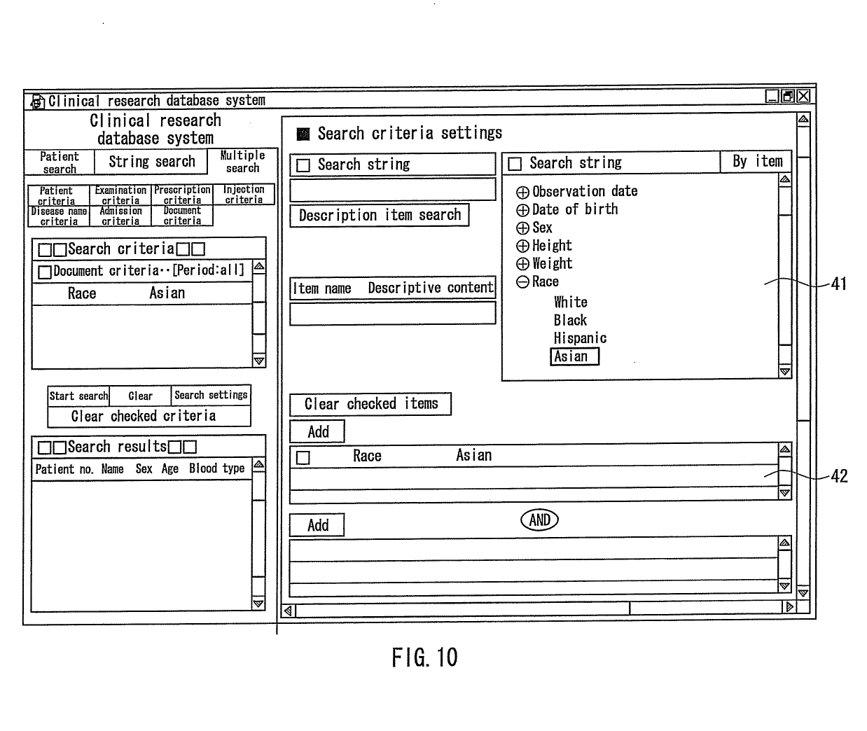

When a searcher starts a search mode in the user terminal 11, a search item selection screen is displayed on the user terminal 11 using the functions of the search criteria setting unit 123 and the display unit 125 (step S31). A configuration is also possible in which the searcher is allowed to select the XML filename (template name of a data entry screen) of data to be searched, when this search item selection screen is called. In the present embodiment, an exemplary search item selection screen in the case where the data of the above “Demographic Data” template is to be searched is shown in FIG. 10. As shown in FIG. 10, the tag names stored in the XML database 122 are displayed on the search item selection screen. Note that in the exemplary screen shown in FIG. 10, there is an item category field 41 in the search item selection screen, with a list of search items being shown in this field. In the FIG. 10 example, the tag names (control names) extracted from the XML file are displayed in the item category field 41 as search items. Also, the items described as the options of one of the tag names (options “White”, “Black”, “Hispanic” and “Asian” for the tag name “Race”) are displayed in the item category field 41 as the search criteria of the search item “Race” at the first subordinate level of this search item. Also, in this example, “Observation Date”, as the dominant concept of the three tag names “Observation Date.yr”, “Observation Date.mth” and “Observation Date.dy”, is displayed as a search item.

The searcher selects a desired search item on this search item selection screen, using a pointing device such as a mouse. Once the searcher has thus selected a search item, the search criteria setting unit 123 acquires the selected search item, and controls the display unit 125 to update the display state of the search item selection screen (step S32). For example, in the FIG. 10 example, “Asian” is set as the search criteria for the search item “Race” in an add search item field 42 of the search item selection screen, as a result of the searcher pointing to “Asian”, which is one of the options in the search item “Race” in the item category field 41.

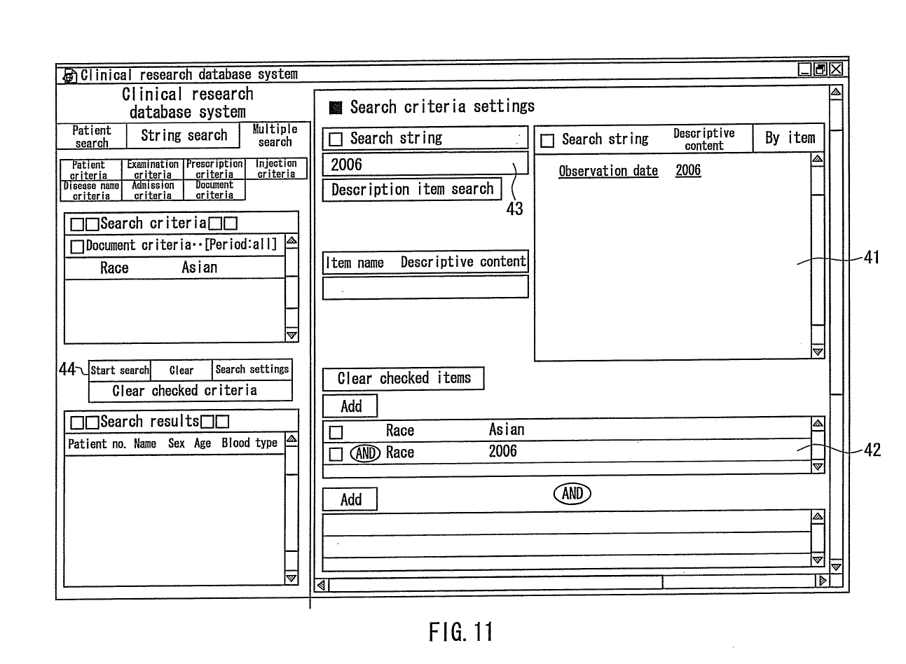

Also, FIG. 11 shows the display state of the search item selection screen when the searcher has further selected “Observation Date” as a search item. “Observation Date” has been added as a search item in the add search item field 42 as a result of the searcher selecting “Observation Date”. Here, the searcher is able to enter refining criteria or the like for the selected search item in a search string input field 43. In the FIG. 11 example, the string “2006” has been entered by the searcher in the search string input field 43 as a refining criterion for the search item “Observation Date”. The criteria “Race” is “Asian” and “Observation Date” is “2006” are thereby set as the search criteria in the FIG. 11 example. Note that in the case of setting a plurality of criteria, the relation between those criteria can also be designated using the AND operator, the OR operator or the like.

As a result of the searcher pressing a Start Search button 44 after thus setting the desired search criteria, the search execution unit 124 refers to the XML database 122 based on the set search criteria, and extracts XML files that include input data matching the search criteria (step S33).

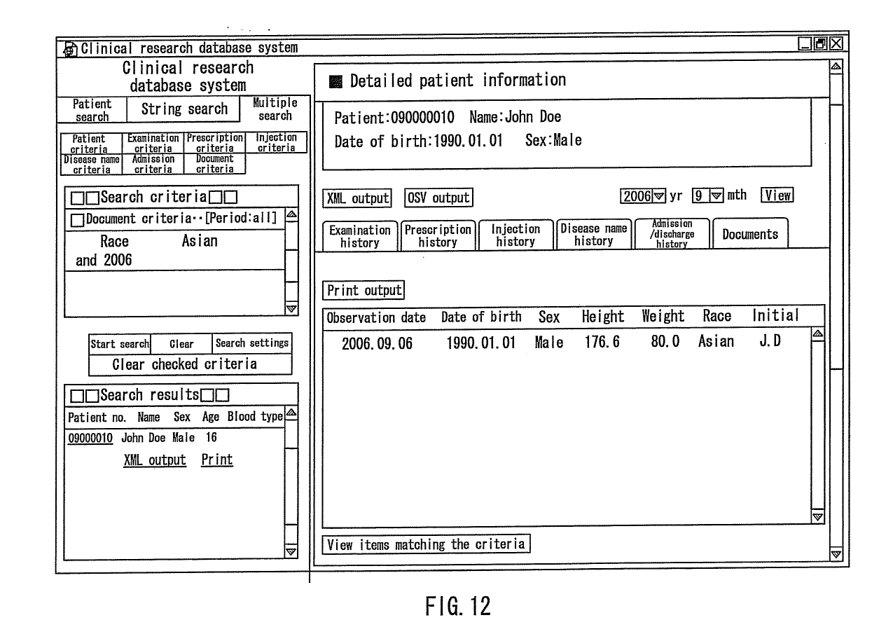

The search execution unit 124 sends the search results to the display unit 125, and the display unit 125 displays the search results on the user terminal 11 as a search results screen such as shown in FIG. 12, for example (step S34). With the display mode of FIG. 12, a readily viewable state is realized even in the case where a plurality of XML files are found in the search, by listing the input data included in the found XML files in table format divided into tag names.

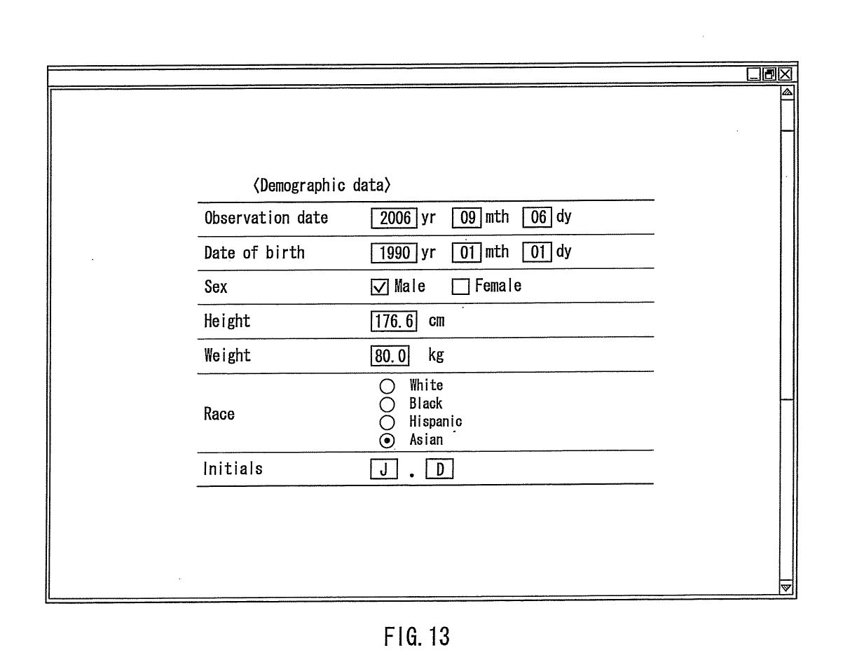

Also, when the searcher clicks a desired line on the search results screen, the display unit 125 is able to display the search result using an image of a data entry screen, as shown in FIG. 13, by acquiring the XML file for that line from the XML database 122, and analyzing and displaying the acquired XML file.

Note that while a search process is performed in the example shown in the above embodiment as a mode of the secondary use of gathered input data, the secondary use of gathered data is not limited to a search process. Gathered data can be used in various applications such as aggregation/statistical processing and graphic processing.

As described above, the data gathering and processing system 1 according to the present embodiment enables input data to be gathered efficiently, and gathered input data to be easily put to secondary use in various applications, by using a structured document such as XML or the like.

### Second Embodiment

Hereinafter, a further example will be described in which a data gathering and processing system of the present invention is applied to clinical trials as a second embodiment.

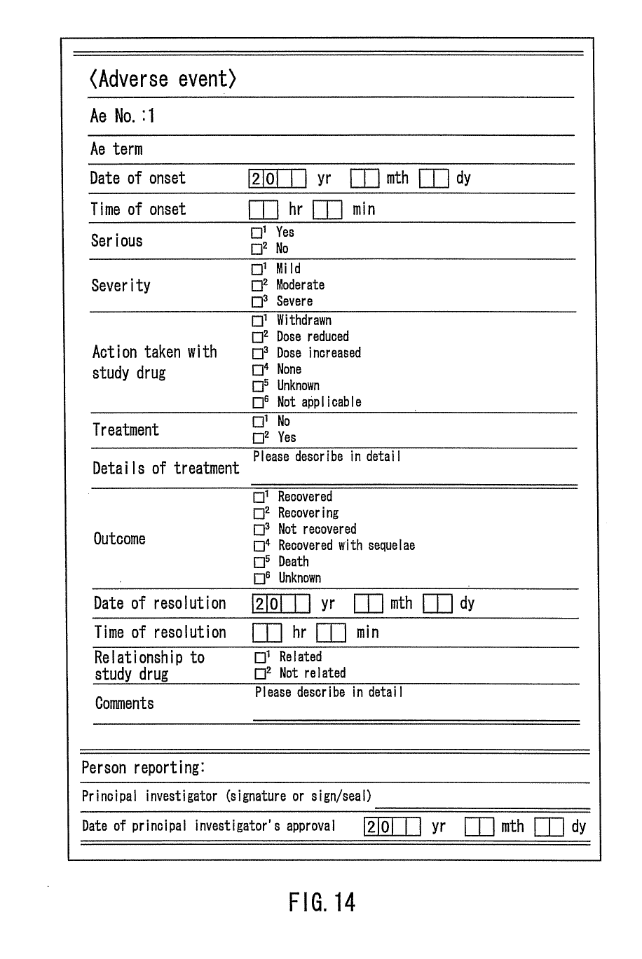

In the case of conducting a clinical trial of a new drug, the pharmaceutical company creates a document called a CRF (Clinical Research Form), which is distributed to the medical institutions implementing the clinical trial. The medical institutions administer the study drug to patients with a specific condition, observe the progress, and provide the CRF to the pharmaceutical company after completing the necessary information. FIG. 14 shows an exemplary CRF. The CRF shown in FIG. 14 is completed when an adverse event of some sort occurs in a patient administered with the study drug, and includes fields for filling out information such as the adverse event term, the date of onset, the time of onset, the seriousness, the degree of severity, the situation with the administration of the study drug, whether there was any treatment and the details thereof, the outcome, the date and time that the event was resolved, the relationship between the event and the study drug, and the physician's comments.

This information also, however, needs to be recorded in the medical records of the medical institutions. Therefore, conventionally this involved a great deal of work since the physician in the medical institution had to record this information in the medical records as well as transcribing the same information to the CRF. Even in the case where the medical institution employed an electronic medical record system, the CRF was conventionally distributed to the medical institution as a paper medium, making it necessary to transcribe the information on the electronic medical record system to the CRF.

Also, the pharmaceutical company is required to dispatch an MRO (Medical Review Officer) to the medical institution and compare the CRF submitted to the pharmaceutical company by the medical institution with the medical records kept at the medical institution, in order to check the accuracy of the CRF submitted by the medical institution at prescribed stages of the clinical trial. This process is called verification. The MRO has to go to the medical institution because the medical records are not allowed to be removed from the medical institution.

As described above, a clinical trial was conventionally a burden on the medical institution which had the hassle of completing the CRF, and on the pharmaceutical company which had to dispatch an MRO to the medical institution and verify the CRF. An object of the data gathering and processing system according to the present embodiment is to reduce both of these loads.

Thus, with the data gathering and processing system according to the present embodiment, the pharmaceutical company creates a template of the CRF using XML, and the passes the created CRF template to the medical institutions implementing the clinical trial as an XML file. There are various methods of delivering the CRF template (XML file) from the pharmaceutical company to the medical institutions at this time, with no particular limitations in this respect. For example, delivery may be performed with the XML file stored on a medium such as a flexible disk (FD) or a CD-ROM. Alternatively, the XML file may be delivered as an attachment to an email or by file transfer from the pharmaceutical company to the medical institutions via the Internet or a dedicated line.

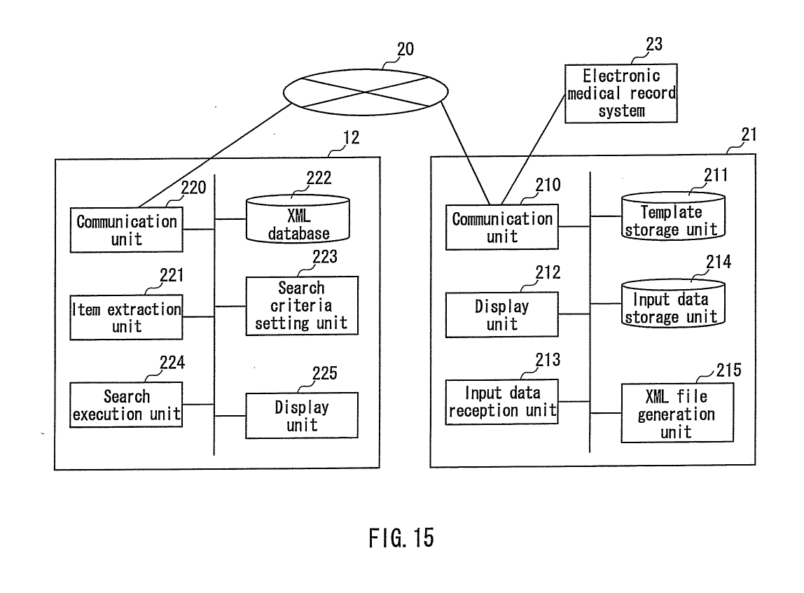

Here, the configuration of the data gathering and processing system according to the present embodiment and a detailed example of the operations thereof will be described. FIG. 15 is a block diagram showing a configuration of the data gathering and processing system according to the present embodiment. As shown in FIG. 15, the data gathering and processing system 2 according to the present embodiment is configured with a terminal 21 of a medical institution communicably connected to a clinical trial data gathering server 22 of a pharmaceutical company via a communication network 20. The terminal 21 of the medical institution is also connected to an electronic medical record system 23 of the medical institution. That is, while both the clinical trial data gathering server 22 and the electronic medical record system 23 are accessible from the terminal 21 of the medical institution, the electronic medical record system 23 of the medical institution is in an environment not directly accessible from the clinical trial data gathering server 22 of the pharmaceutical company. The communication network 20 may be a wide area network such as the Internet or a dedicated line. Also, the communication network 20 does not need to continuously connect the terminal 21 of the medical institution and the clinical trial data gathering server 22 of the pharmaceutical company. Note that while only a single terminal 21 is illustrated in FIG. 15, there may be a plurality of terminals.

The terminal 21 of the medical institution is realized, for example, by a personal computer with a browser installed, and displays data entry screens written in a structured document (XML in the present embodiment).

Note that since the functions of a communication unit 210, a template storage unit 211, a display unit 212, an input data reception unit 213, an input data storage unit 214, and an XML file generation unit (structured document generation unit) 215 in the terminal 21 of the medical institution are the same as the functions of the corresponding units in the user terminal 11 shown in FIG. 2 of the first embodiment, a detailed description will be omitted.

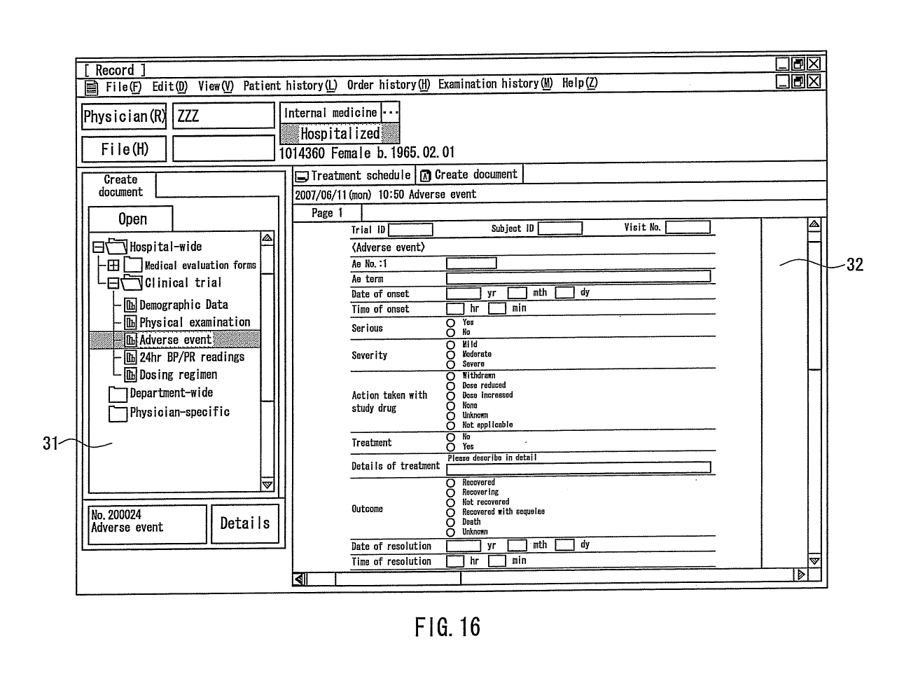

In the data gathering and processing system of the present embodiment, a template (hereinafter, called a CRF template) for displaying on a display of the terminal 21 is created in the pharmaceutical company using XML, with the format of the CRF shown in FIG. 14 as the data entry screen (see the main screen 32 in FIG. 16). A CRF template such as this can be created using a known XML editor or the like. The created CRF template is distributed from the pharmaceutical company to the medical institutions conducting the clinical trial. Note that method of distributing this CRF template is arbitrary. For example, the CRF template may be distributed by email from the clinical trial data gathering server 22 via the communication network 20, or can be downloaded from the clinical trial data gathering server 22. Alternatively, the CRF template may be distributed to the medical institutions using any of a variety of recording media on which the CRF template is recorded, rather than via the communication network 20.

The terminal 21 of the medical institution stores the CRF template distributed from the pharmaceutical company in the template storage unit 211 as an XML file. The XML file of a CRF template stored in the template storage unit 211 can be selected in the terminal 21 from a document selection field 31 displayed on a screen, similarly to the first embodiment. Once the operator of the terminal 21 has selected a CRF template, the display unit 212 extracts the XML file of the selected CRF template from the template storage unit 211, and displays a data entry screen on the terminal 21 in accordance with the document definition of the extracted XML file. FIG. 16 shows an exemplary display on the terminal 21. In the FIG. 16 example, the CRF template for “Adverse Event” selected in the document selection field 31 is displayed on the main screen 32. Note that this template is merely by way of example, and a template tailored to the type of information required in a clinical trial can be created arbitrarily.

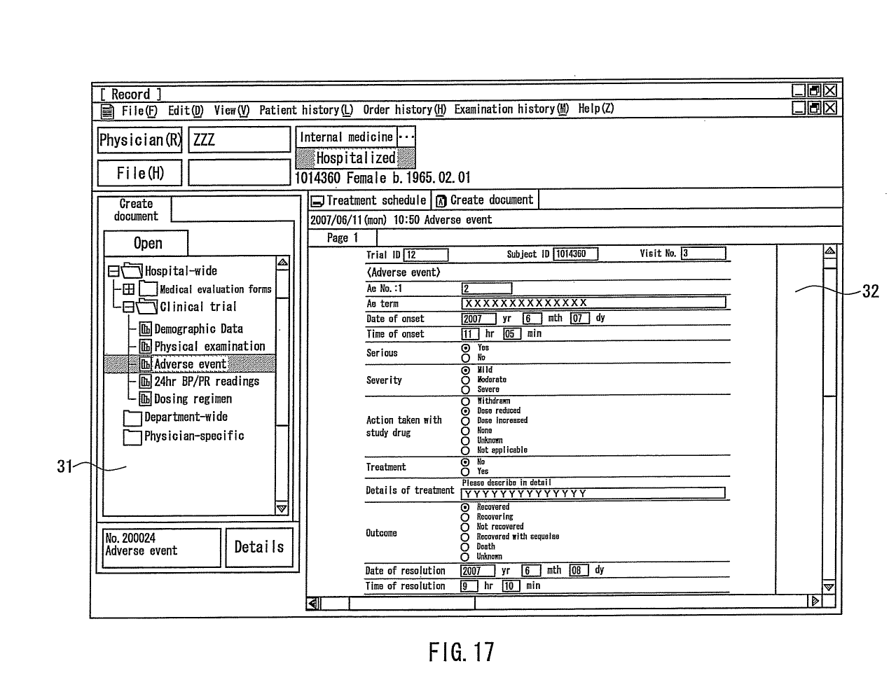

Here, the operator of the terminal 21 is able to appropriately enter information obtained in the clinical trial into the data entry screen displayed on the terminal 21, as shown the FIG. 17. In the FIG. 17 example, information on an adverse event that occurred in the clinical trial has been entered.

Once data has thus been entered into the data entry screen, the input data reception unit 213 detects the data entered into the data entry screen of the terminal 21, and at least temporarily stores the detected input data in the input data storage unit 214 together with the tag names into which the data was entered, similarly to the procedure described in the first embodiment. Once data entry to the data entry screen is complete, the XML file generation unit 215 creates an XML file with data describing the layout of the data entry screen that includes input data, with reference to the template storage unit 211 and the input data storage unit 214. The generated XML file with data is transmitted from the terminal 21 to the clinical trial data gathering server 22 of the pharmaceutical company via the communication network 20.

The clinical trial data gathering server 22 is provided with a communication unit 220, an item extraction unit 221, an XML database 222, a search criteria setting unit 223, a search execution unit 224 and a display unit 225, as shown in FIG. 15. Note that the XML database 222 may be constructed externally to the data gathering server 22 (e.g., on a disk apparatus or a file server accessible from the data gathering server 22). The communication unit 220, the item extraction unit 221, the search criteria setting unit 223, the search execution unit 224 and the display unit 225 are respectively functional means realized as a result of a processor of the data gathering server 22 running a prescribed computer program, and need not necessarily be implemented separately as independent hardware. Note that since the functions of the communication unit 220, the item extraction unit 221, the XML database 222, the search criteria setting unit 223, the search execution unit 224 and the display unit 225 are the same as the functions of the corresponding units of the data gathering server 12 shown in FIG. 2 of the first embodiment, a detailed description will be omitted.

When an XML file is transmitted from the terminal 21, the communication unit 220 in the clinical trial data gathering server 22 receives the XML file. The received XML file is stored in the XML database 222. At this time, the item extraction unit 221 extracts the tag names corresponding to the input data items from the XML file, and stores the extracted tag names in the XML database 222 in association with the XML file. The tag names extracted by the item extraction unit 221 are used as options for allowing a searcher to select a search item in the search process. Note that when storing a received XML file in the XML database 222, parts of the description not related to the input data in the XML file may be removed, for example, and only those parts including description related to significant input data may be stored in the XML database 222 in order to conserve storage capacity.

The above procedure enables data entered from the terminal 21 to be gathered in the XML database 222 of the clinical trial data gathering server 22 as an XML file. Note that the tag name extraction process may be performed in the terminal 21, and the extracted tag names sent to the clinical trial data gathering server 22 together with the XML file and stored in the XML database 222, similarly to the first embodiment.

Also, similarly to the item extraction unit 121 of the first embodiment, in the case where options or the like for a tag name are described in the XML, the item extraction unit 221, rather than only extracting the tag name as a search item from the XML file, preferably extracts these options or the like as search criteria for the search item. In the case where there is a dominant concept common to a plurality of tags, the item extraction unit 121 may extract the item name representing the dominant concept of those tag names as a search item.

As a result of the above processing, the data gathering and processing system according to the second embodiment enables information on a clinical trial to be gathered in the clinical trial data gathering server 22 simply by displaying the template of a CRF in the terminal 21 in electronic form as a data entry screen, and entering information obtained in the clinical trial into this data entry screen. Also, the item extraction unit 221 in the clinical trial data gathering server 22 extracts tag names that can be used as search items, enabling the search process to be readily performed in the clinical trial data gathering server 22. Note that since the procedure of the search process in the clinical trial data gathering server 22 is similar to the processing shown in FIG. 9 in the first embodiment, a detailed description will be omitted.

In the second embodiment, information entered into a data entry screen of the terminal 21 in a medical institution can be used by the electronic medical record system 23 of the medical institution without modification. That is, the terminal 21 captures the data entry screen with data entered therein as shown in FIG. 17, for example, as an image, and transmits the image to the electronic medical record system 23 in file form. Alternatively, an XML file of the data entry screen generated by the XML file generation unit 215 may be sent to the electronic medical record system 23. In the electronic medical record system 23, the file of the data entry screen can be stored on a hard disk or the like, and read out for use as necessary. This enables the work involved in transcribing items on a CRF to an electronic medical record system, as was conventionally the case, to be omitted.

Hereinbefore, an example in which the data gathering and processing system of the present invention is used in the data gathering of a clinical trial was described in the first and second embodiments, although the application field of the data gathering and processing system of the present invention is not limited to only clinical trials or the medical field, but includes various data gathering and secondary use of gathered data.

While preferred embodiments have been described above with reference to the drawings, it will be apparent to those skilled in the art that various changes and modifications may be made to the embodiments of the invention without departing from the spirit or teachings of the invention. Accordingly, the foregoing embodiments are merely specific examples for illustrating the invention, and are not intended to limit the scope of thereof.

1. A data gathering and processing system comprising:
a template storage unit storing a structured document describing a template of a data entry screen layout;
a display unit that displays a data entry screen by analyzing a structured document corresponding to a template selected by a data inputter;
an input data storage unit that, when there is data entry to the data entry screen, at least temporarily stores input data in association with a tag name corresponding to the input data;
a structured document generation unit that, when data entry to the data entry screen is complete, generates a structured document with data describing a layout of a data entry screen that includes input data, with reference to a structured document corresponding to a template of the data entry screen, and to the input data and the tag name stored in the input data storage unit;
an item extraction unit that extracts, as a search item, at least a tag name from the structured document with data;
a database that stores, in association with at least a portion of the structured document with data, the search item extracted by the item extraction unit from the structured document with data;
a search criteria setting unit that displays the search item and receives a search criteria related to the search item from a searcher; and
a search execution unit that searches the database based on the search criteria received from the searcher, and presents input data obtained as a search result or a data entry screen that includes the input data.

2. The data gathering and processing system according to claim 1, wherein the structured document is HTML or XML.

3. The data gathering and processing system according to claim 1, wherein the input data is data related to a clinical trial.

4. A computer program for causing a computer to execute the processes of:
displaying a data entry screen by reading out, from a template storage unit storing a structured document describing a template of a data entry screen layout, a structured document corresponding to a template selected by a data inputter and analyzing the read structured document;
at least temporarily storing in an input data storage unit when there is data entry to the data entry screen, input data in association with a tag name corresponding to the input data;
generating, when data entry to the data entry screen is complete, a structured document with data describing a layout of a data entry screen that includes input data, with reference to a structured document corresponding to a template of the data entry screen, and to the input data and the tag name stored in the input data storage unit;
extracting, as a search item, at least a tag name from the structured document with data, and storing, in a database, the extracted search item in association with at least a portion of the structured document with data;
displaying the search item and receiving a search criteria related to the search item from a searcher; and
searching the database based on the search criteria received from the searcher, and presenting input data obtained as a search result or a data entry screen that includes the input data.
